(19) United States
(12) Patent Application Publication
(10) Pub. No.: US 2011/0032450 A1
(43) Pub. Date: Feb. 10, 2011

(54) LED LIGHT SOURCE DEVICE, BACKLIGHT DEVICE AND LIQUID CRYSTAL DISPLAY DEVICE

(76) Inventors: Hiroaki Shigeta, Osaka (JP); Koji Yamabuchi, Osaka (JP)

Correspondence Address: BIRCH STEWART KOLASCH & BIRCH, PO BOX 747, FALLS CHURCH, VA, 22040-0747, US

(21) Appl. No.: 12/937,775

(22) PCT Filed: Jan. 8, 2009
(86) PCT No.: PCT/JP2009/050109

§ 371 Date: Oct. 14, 2010

(30) Foreign Application Priority Data
May 27, 2008 (JP) 2008-138311

(51) Int. Cl. G02F 1/1335; H01J 1/62; G09F 13/04

(52) U.S. Cl. 349/61; 313/501; 362/97.1

(57) ABSTRACT

Provided is an LED light source having improved luminance characteristics. The LED light source device (1) is provided with a light emitting body (12) mounted on a mounting surface (11a) of a base member (11), and a transparent resin member (13), which is formed on the mounting surface (11a) and provided with a light emitting surface (13a) and a side end surface (13b). The side end surface (13b) is tilted so that the length of the light emitting surface (13a) in the lateral direction is longer than the length of the mounting surface (11a) in the lateral direction, and an interface between the side end surface (13b) and atmosphere is permitted to be a reflecting surface.

### TECHNICAL FIELD

The present invention relates to an LED light source, a backlight device and a liquid crystal display device.

### BACKGROUND ART

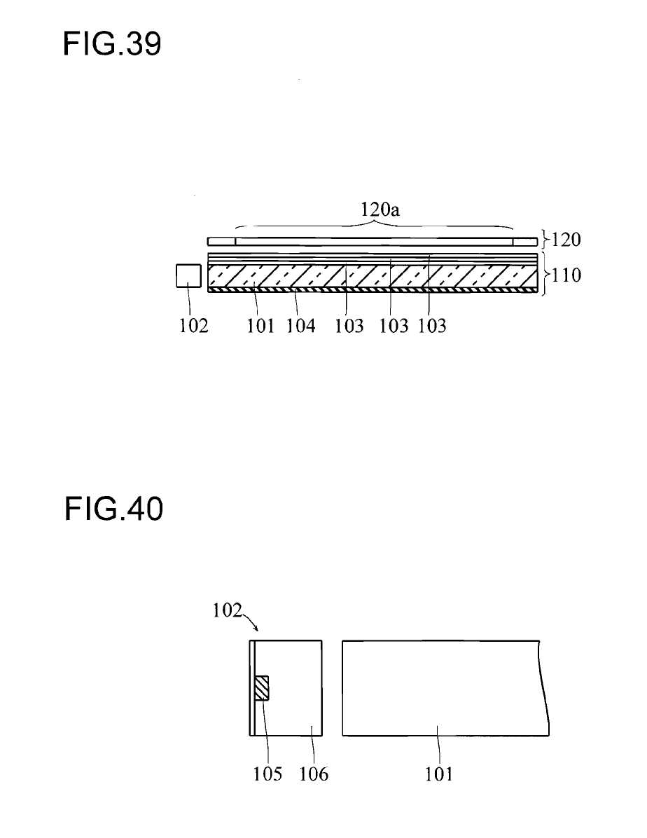

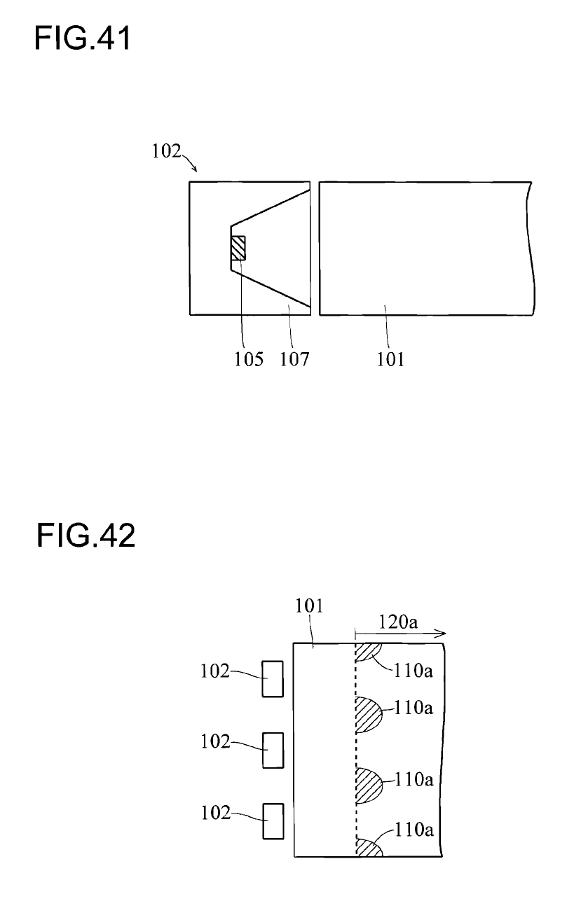

Conventionally, an LED light source device that includes at least a light emitting diode element is known; and is used as a light source of a backlight device that is disposed in a liquid crystal display device. Hereinafter, a conventional backlight device and an LED light source device used as a light source of the backlight device are described with reference to FIG. 39 to FIG. 41. Here, FIG. 39 is a simplified view of the conventional backlight device; FIG. 40 and FIG. 41 are simplified views of the conventional LED light source device.

The conventional backlight device 110, as shown in FIG. 39, includes: a light guide plate 101; an LED light source device 102; an optical sheet 103; and a reflection sheet 104. Here, the backlight device 110 shown in FIG. 39 is an edge-light type.

The light guide plate 101 is formed of a plate-shape member; and has four side end surfaces and two surfaces (front surface and rear surface) perpendicular to the four side end surfaces. A predetermined side end surface of the four side end surfaces of the light guide plate 101 functions as a light incident surface for introducing light from the LED light source device 102 into the inside; and the front surface of the light guide plate 101 functions as a light output surface for outputting the light introduced in the inside into a surface shape. The LED light source device 102 is disposed to the light incident surface side of the light guide plate 101; the optical sheet 103 and the reflection sheet 104 are respectively disposed on the light output surface and on the rear surface of the light guide plate 101. Here, to secure sufficient brightness, a plurality of the LED light source devices 102 are disposed along the light incident surface of the light guide plate 101 at a predetermined interval away from each other.

Besides, the LED light source device 102 has such structures as are shown in FIG. 40 or FIG. 41, for example. Specifically, the LED light source device 102 shown in FIG. 40 has a structure in which the light emitting diode element 105 is encapsulated by a rectangular-parallelepiped-shape encapsulation member 106. Besides, the LED light source device 102 shown in FIG. 41 has a structure in which a circumference of the light emitting diode element 105 is enclosed by a light reflection member (inclined surface) 107 (e.g., see patent document 1).

And, in the conventional backlight device 110 shown in FIG. 39, when light is generate by the LED light source device 102, the light is introduced from the light incident surface (predetermined side end surface) of the light guide plate 101 and output from the light output surface (front surface) of the light guide plate 101. Thereafter, the light output from the light output surface of the light guide plate 101 is diffused and collected by the optical sheet 103 and shines on the rear surface of the liquid crystal display panel 120. As a result of this, a desired image is displayed on a display region 120a of the liquid crystal display panel 120. Here, light that leaks from the rear surface of the light guide plate 101 is reflected by the reflection sheet 104 to be reintroduced.

Patent document 1: JP-A-2007-150315

### DISCLOSURE OF THE INVENTION

### Problems to be Solved by the Invention

However, in a case where the above conventional LED light source device 102 is used as the light source of the backlight device 110, such disadvantages as are described below occur.

Specifically, in a case where the LED light source device 102 shown in FIG. 40 is used, because the light emitting diode element 105 is encapsulated by the rectangular-parallelepiped-shape encapsulation member 106, the light totally reflected at the interface between the light output surface of the LED light source device 102 and the atmosphere increases. Because of this, the amount of light output from the light output surface of the LED light source device 102 decreases, so that the brightness becomes low.

Moreover, in this case, a lateral-direction spread of the light output from the LED light source device 102 becomes uneven. Because of this, as shown in FIG. 42, if it is tried to achieve narrow framing of the backlight device 110 by shortening the distance from the LED light source device 102 to an effective light emitting area (region corresponding to the display region 120a of the liquid crystal display panel 120), a region 110a in FIG. 42 becomes dark, which causes brightness unevenness (“eyeball” unevenness).

Besides, in a case where the LED light source device 102 shown in FIG. 41 is used, because the circumference of the light emitting diode element 105 is enclosed by the light reflection member (inclined surface) 107, it is possible to solve the above disadvantage; however, the thickness (the height of the light output surface of the LED light source device 102) of the LED light source device 102 becomes large. Because of this, if it is tried to achieve thickness reduction of the backlight device 110 by decreasing the thickness of the light guide plate 101, it becomes hard for the light output from the LED light source device 102 to be introduced into the light guide plate 101, so that the brightness becomes low.

The present invention has been made to deal with the conventional problems, and it is an object of the present invention to provide an LED light source device, a backlight device and a liquid crystal display device that are able to improve a brightness characteristic.

### Means for Solving the Problem

To achieve the object, an LED light source device according to a first aspect of the present invention includes: a base member that has a mount surface facing in a light output direction; a light emitting body that is mounted on the mount surface of the base member and includes at least a light emitting diode element; and a transparent resin member that is so formed on the mount surface of the base member as to cover the light emitting body; has a light output surface facing in the light output direction and a side end surface for connecting the light output surface and the mount surface of the base member to each other; guides light generated by the light emitting body to output the light from the light output surface; wherein the side end surface of the transparent resin member is inclined in such a way that a lateral-direction length of the light output surface becomes longer than the lateral-direction length of the mount surface of the base member; and an interface between the side end surface inclined of the transparent resin member and atmosphere serves as a light reflection surface.

In the LED light source device according to the first aspect of the present invention, as described above, the side end surface of the transparent resin member, which is so formed on the mount surface of the base member as to cover the light emitting body, is inclined, so that because the light generated by the light emitting body reflects off the inclined side end surface of the transparent resin member, it is possible to prevent the light from being totally reflected at the interface between the light output surface of the transparent resin member and the atmosphere. Because of this, it is possible to increase the light that is output from the LED light source device. Accordingly, if the LED light source device according to the present invention is used as a light source of a backlight device, the light introduced into a light guide plate increases, so that it is possible to improve the brightness.

In this case, the side end surface of the transparent resin member is inclined in such a way that the lateral-direction length of the light output surface of the transparent resin member becomes larger than the lateral-direction length of the mount surface of the base member, so that because the light output surface of the transparent resin member becomes large in the lateral direction, it is possible to evenly spread the light output from the LED light source device in the lateral direction. Accordingly, if the LED light source device according to the present invention is used as a light source of a backlight device, in a case where it is tried to achieve narrow framing of the backlight device by shortening the distance from the LED light source device to an effective light emitting area (region corresponding to a display region of a liquid crystal display panel), it is possible to prevent occurrence of a disadvantage that brightness unevenness (eyeball unevenness) occurs.

Besides, by using the interface between the inclined side end surface of the transparent resin member and the atmosphere as the light reflection surface, there is no need to enclose the circumference of the light emitting diode element by means of a light reflection member and the like separately prepared, so that it is possible to reduce the thickness (the height of the light output surface of the LED light source device) of the LED light source device. Accordingly, if the LED light source device according to the present invention is used as a light source of a backlight device, in a case where it is tried to achieve thickness reduction of the backlight device by reducing the thickness (the height of the light incident surface (predetermined side end surface) of the light guide plate) of the light guide plate, it is possible to lower the height of the light output surface of the LED light source device in accordance with the height of the light incident surface (predetermined side end surface) of the light guide plate. As a result of this, it is possible to prevent occurrence of a disadvantage that it becomes hard for the light output from the LED light source device to enter the light guide plate; and because of this, the brightness becomes low.

Because of these results, by using the LED light source device according to the present invention as a light source of a backlight device, even if it is tried to achieve size reduction (thickness reduction and narrow framing) of the backlight device, it is possible to prevent the brightness characteristic from becoming low.

In the LED light source device according to the above first aspect, preferably, the light emitting body includes: a light emitting diode element for emitting blue light, and a fluorescent body for absorbing the blue light to emit fluorescent light; and emits white light obtained by color-mixing the blue light and the fluorescent light with each other. According to this structure, in comparison with a case where white light is generated by means of a light emitting diode element that emits red light, a light emitting diode element that emits green light and a light emitting diode element that emits blue light, it is possible to achieve further size reduction of the LED light source device.

In the LED light source device according to the above first aspect, preferably, the side end surface of the transparent resin member is linearly inclined; and when a refractive index of the atmosphere is n₀ and a refractive index of the transparent resin member is n₁, an inclination angle θ₁ of the side end surface of the transparent resin member to a normal of the light output surface is so set as to meet 70°≧θ₁>sin⁻¹(n₀/n₁).

Besides, in the LED light source device according to the above first aspect, preferably, the side end surface of the transparent resin member is inclined in a curved-surface shape; and a curvature of the side end surface of the transparent resin member is set in such a way that the light from the light emitting body is totally reflected in the light output direction at the interface between the side end surface of the transparent resin member and the atmosphere.

In the LED light source device according to the above first aspect, it is preferable that the transparent resin member is provided with a concave portion that is dug from the light output surface toward the base member side. According to this structure, because the concave portion of the transparent resin member serves as a light diffusion region, it is possible to further widen the spread of the light in the lateral direction in the inside of the transparent resin member. Accordingly, if the LED light source device according to the present invention is used as a light source of a backlight device, it becomes unnecessary to additionally form a light diffusion region in the light guide plate. In other words, because it becomes unnecessary to apply a complicated process to the light guide plate, it is possible to reduce the fabrication cost. Besides, in a case where the light guide plate is provided with a light diffusion region, the position of the light diffusion region and the position of the LED light source device are likely to deviate from each other to lower a light diffusion effect; however, in the present invention, such a disadvantage does not occur.

In the above description, preferably, the concave portion of the transparent resin member is formed into a V shape; and an inclination angle θ₂ of an inner surface of the concave portion of the transparent resin member to a normal of the light output surface is so set as to meet 70°≧θ₂≧45°.

Besides, in the above description, preferably, the concave portion of the transparent resin member is formed into a semicircular shape; and when a length of a long edge of the light emitting diode element is L and a length from the light emitting diode element to the light output surface is S, a radius R of the concave portion of the transparent resin member is so set as
to meet S≧R≧L/2. According to this structure, it is possible to further improve the light diffusion effect in the inside of the transparent resin member.

In the LED light source device according to the above first aspect, preferably, the transparent resin member is formed in such a way that thickness of the light output surface side becomes smaller than thickness of the base member side. According to this structure, in the case where the LED light source device according to the present invention is used as a light source of a backlight device, even if the thickness (the height of the light incident surface (predetermined side end surface) of the light guide plate) of the light guide plate is further reduced, a disadvantage that it becomes hard for the light output from the LED light source device to enter the light guide plate does not occur. Because of this, it is possible to achieve further thickness reduction of the backlight device.

In the above description, it is preferable that the transparent resin member is formed in such a way that the thickness gradually becomes smaller from the base member side toward the light output surface side at an inclination angle of 20° or lager to an angle smaller than 45°; and a difference between the thickness of the light output surface side and the thickness of the base member side becomes 0.1 mm or larger.

In the LED light source device according to the above first aspect, it is preferable that on the mount surface of the base member, an electric power supply line that supplies electric power to the light emitting diode element is formed; and on a predetermined surface different from the mount surface of the base member, an external terminal connected to the electric power supply line is formed. According to this structure, in mounting the light emitting diode element onto the mount surface of the base member, it is possible to easily perform electrical connection of the light emitting diode element to the electric power supply line (external terminal). Because of this, it is possible to improve the producibility of the LED light source device. Besides, because it is possible to enlarge the area of the external terminal, it is possible not only to easily perform the mounting of the LED light source device onto an external device (electrical connection between an external terminal of the external device and the external terminal of the LED light source device) but also to improve electrical conductivity from the external device to the light emitting diode element.

In the above description, preferably, at least one of the electric power supply line and the external terminal includes a laminated body of a Cu-plated layer and a Ni—Ag-plated layer. According to this structure, it is possible to improve electrical conductivity from the external device to the light emitting diode element while preventing oxidation of Cu and migration of Ag.

Besides, in the above description, it is preferable that the electric power supply line includes a laminated body of a Cu-plated layer and a Ni—Ag-plated layer; and the external terminal includes an Au-plated layer. According to this structure, it is possible to improve durability of the external terminal. Besides, in a case where devices different from each other are mounted onto the external device, it is easy to perform the mounting of these devices onto the external device.

A backlight device according to a second aspect of the present invention includes the LED light source device according to the above first aspect. According to this structure, it is possible to easily improve the brightness characteristic.

Besides, a liquid crystal display device according to a third aspect of the present invention includes: the backlight device according to the above second aspect; and a liquid crystal display panel on which light from the backlight device shines. According to this structure, it is possible to improve the brightness characteristic.

### ADVANTAGES OF THE INVENTION

As described above, according to the present invention, it is possible to easily obtain an LED light source device, a backlight device and a liquid crystal display device that are able to improve a brightness characteristic.

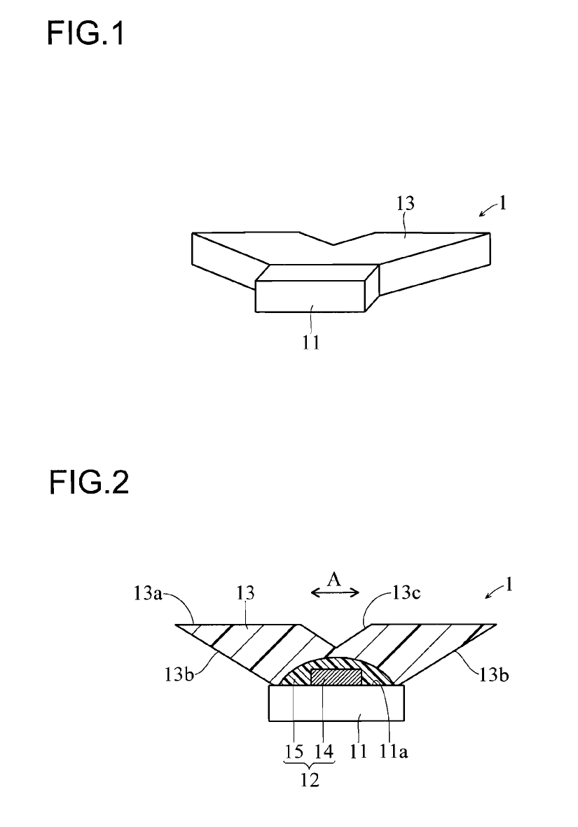

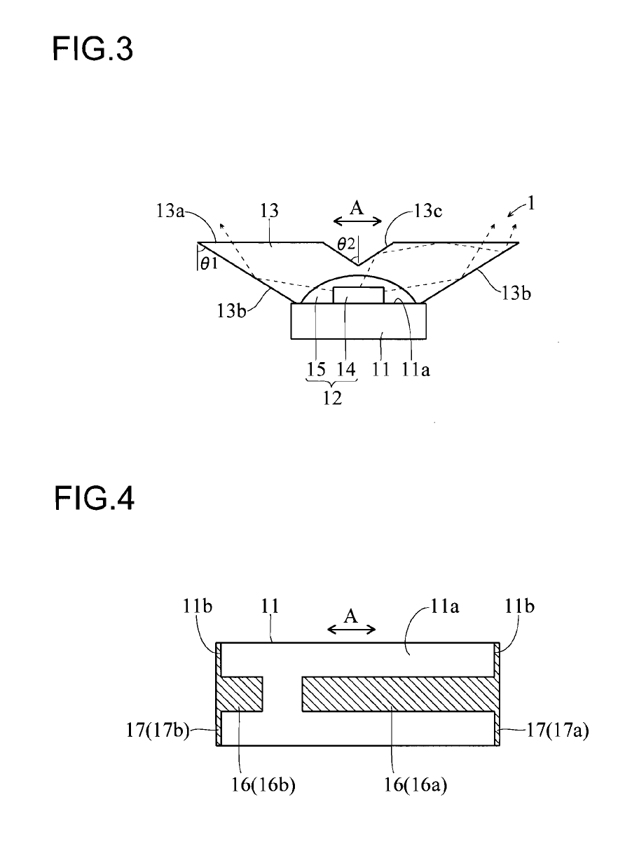

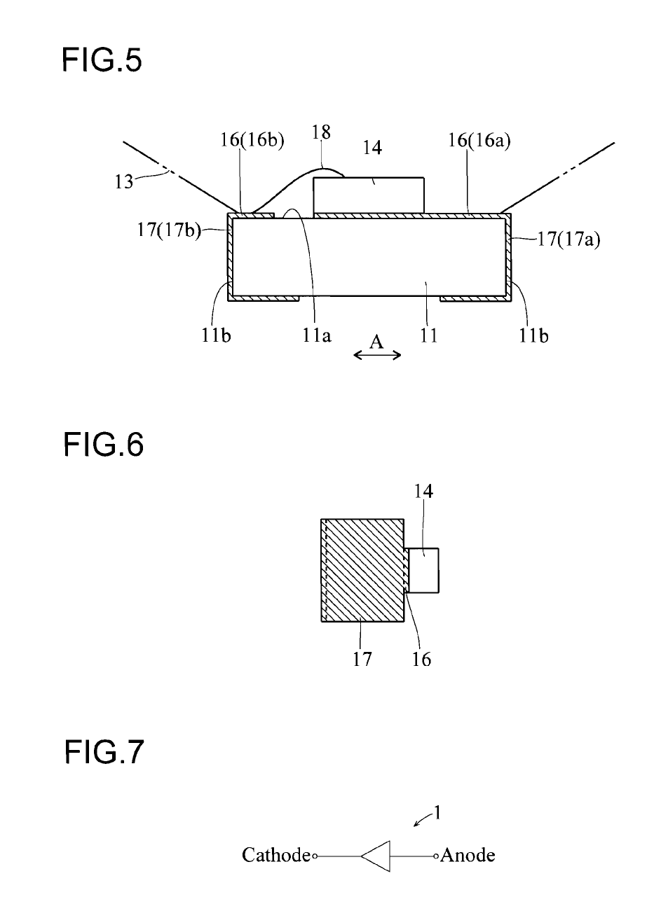

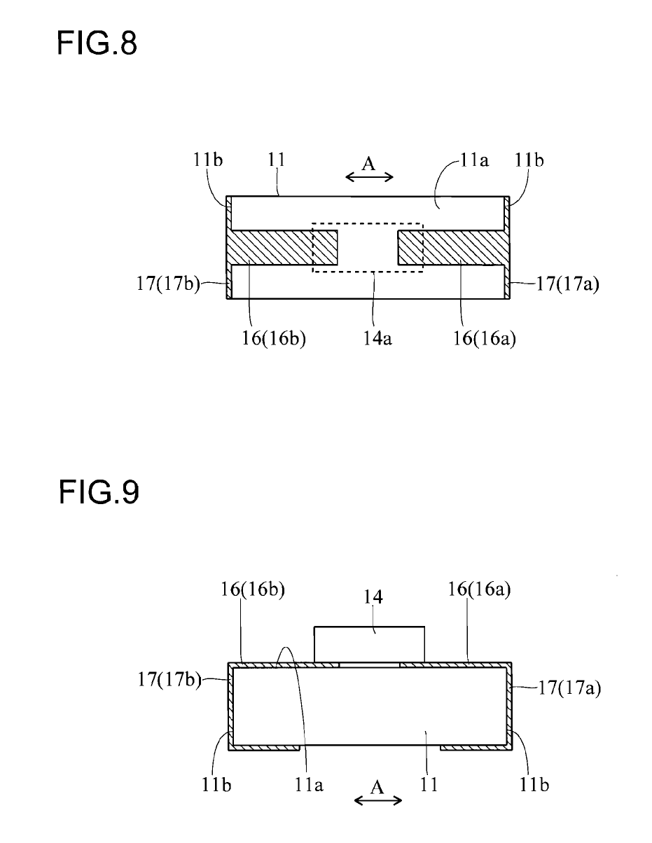

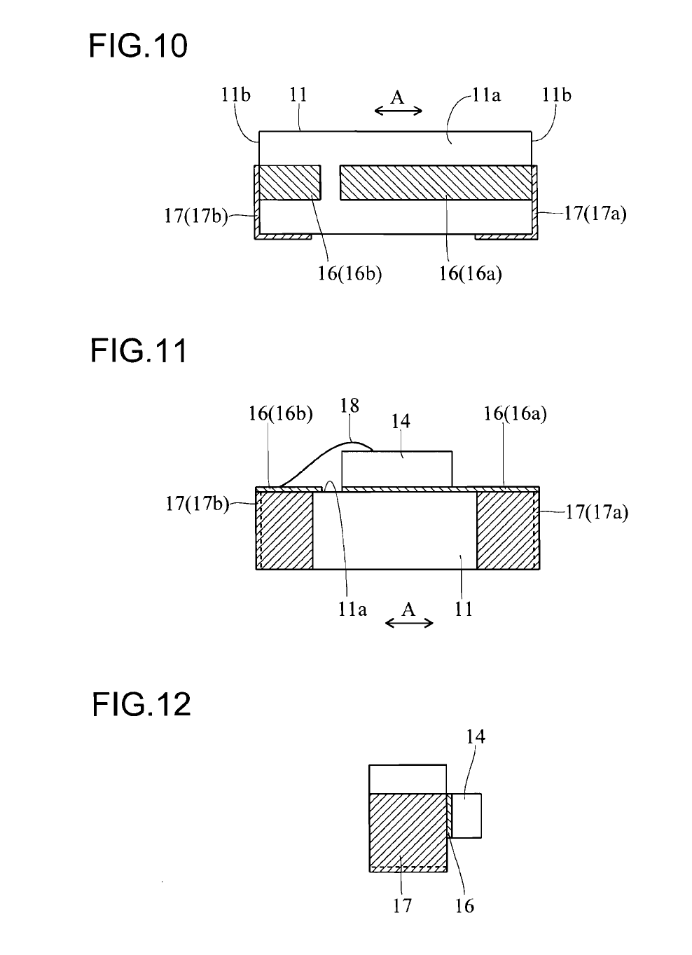

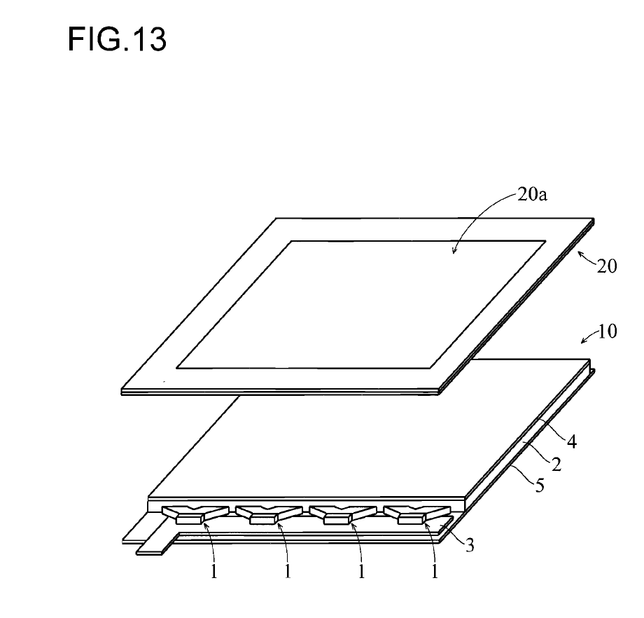

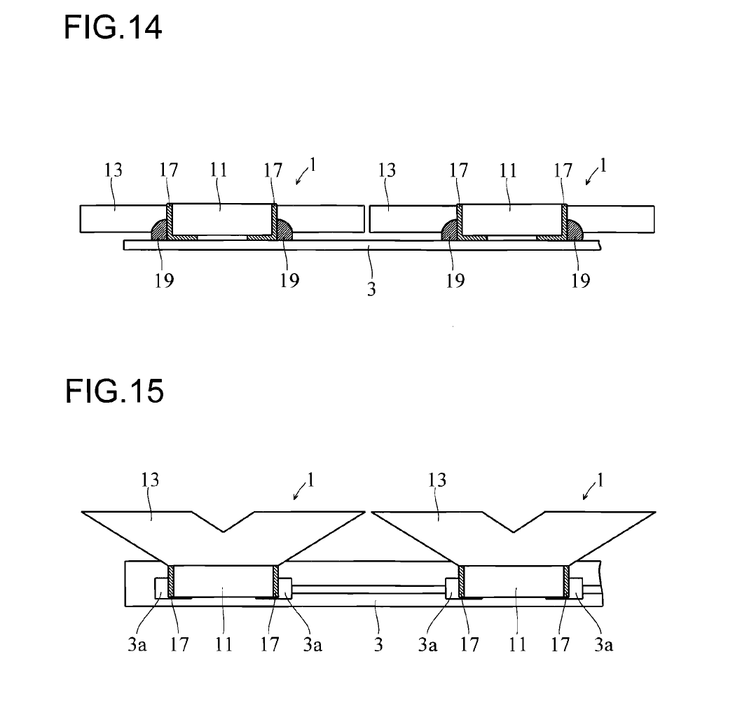

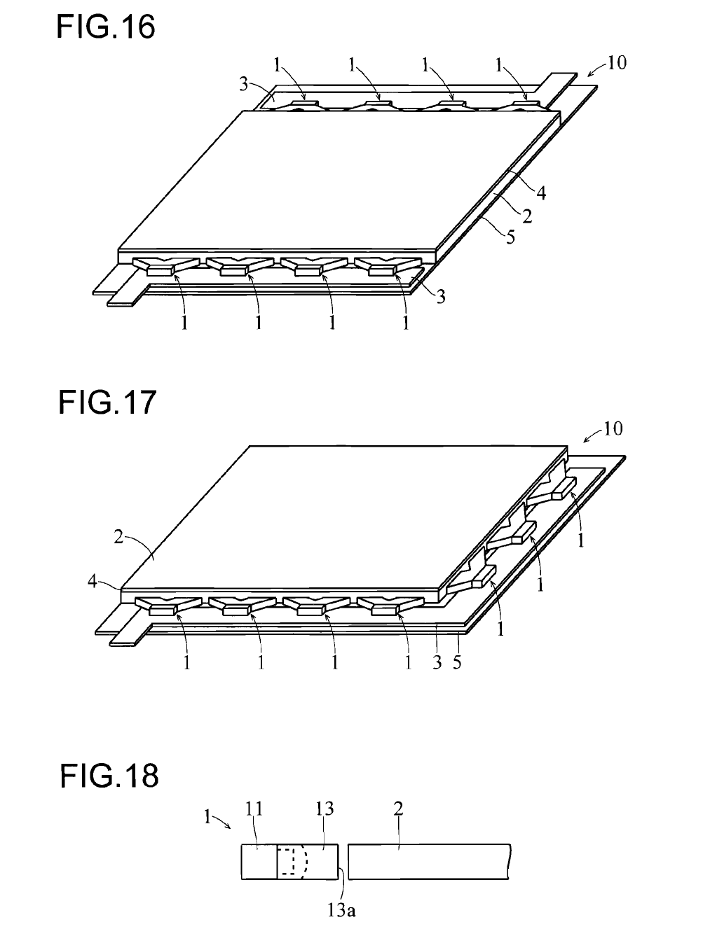

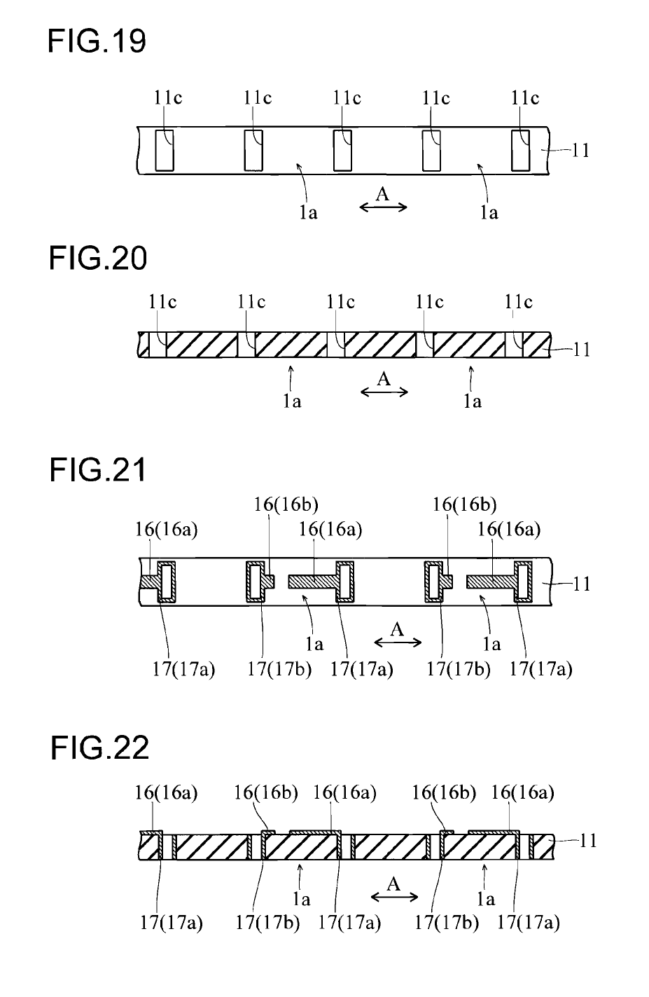

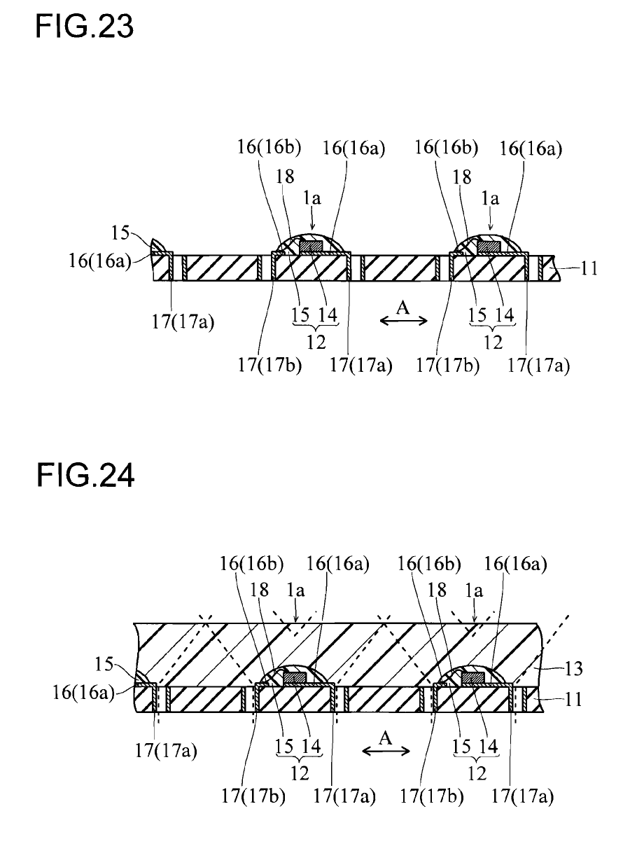

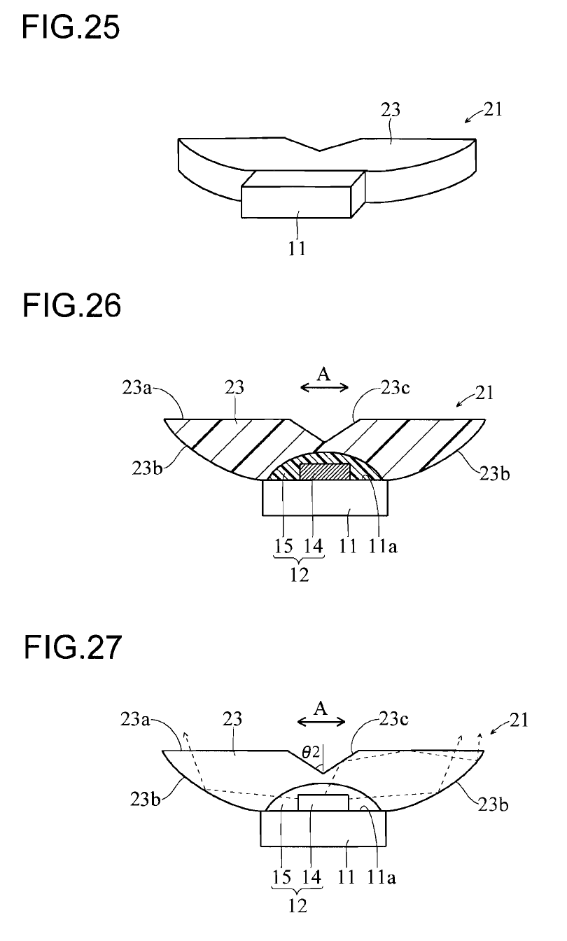

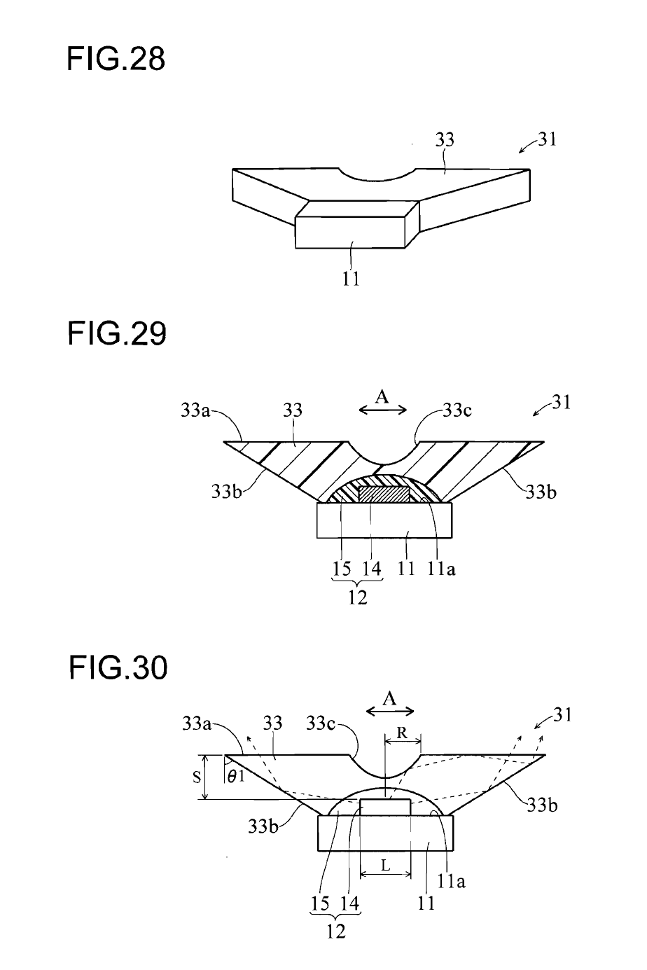

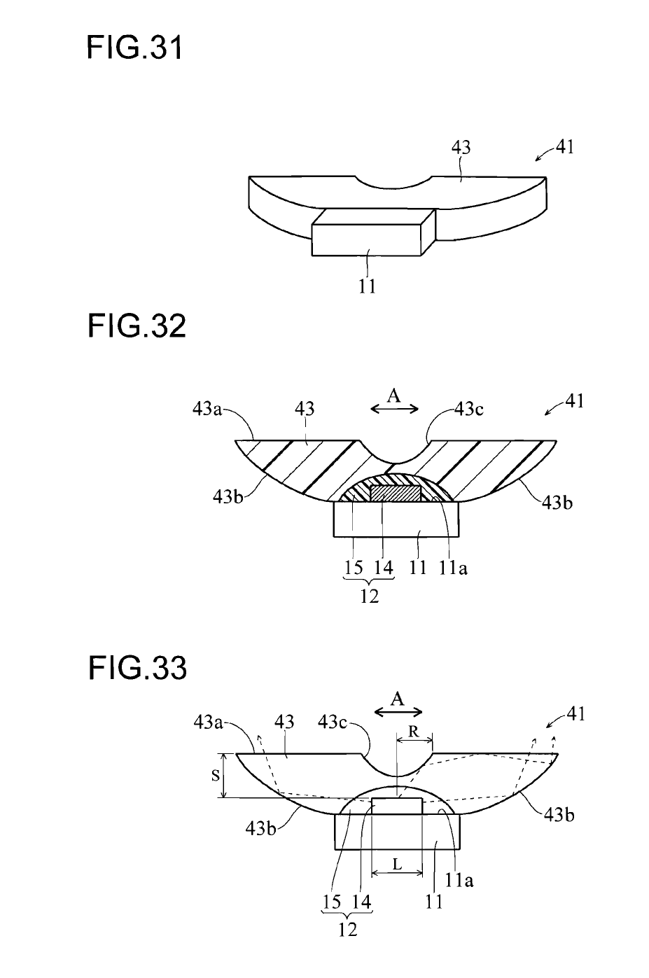

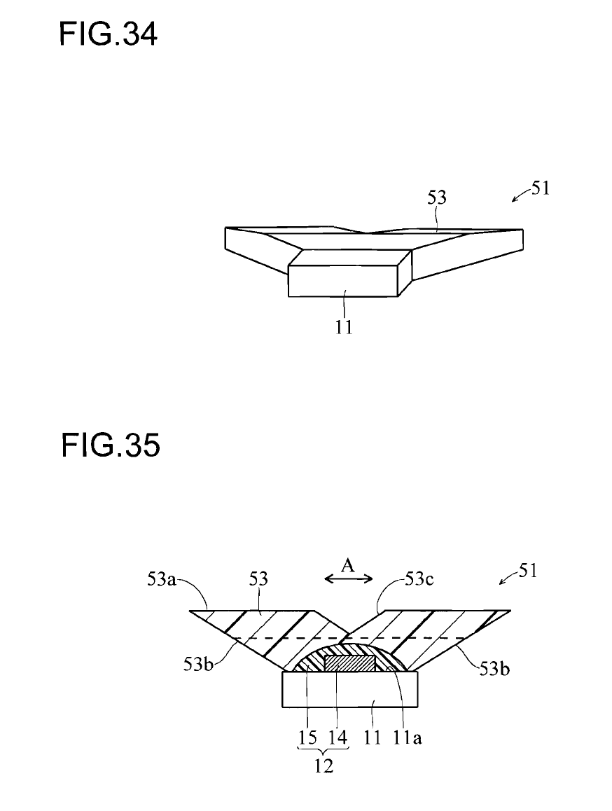

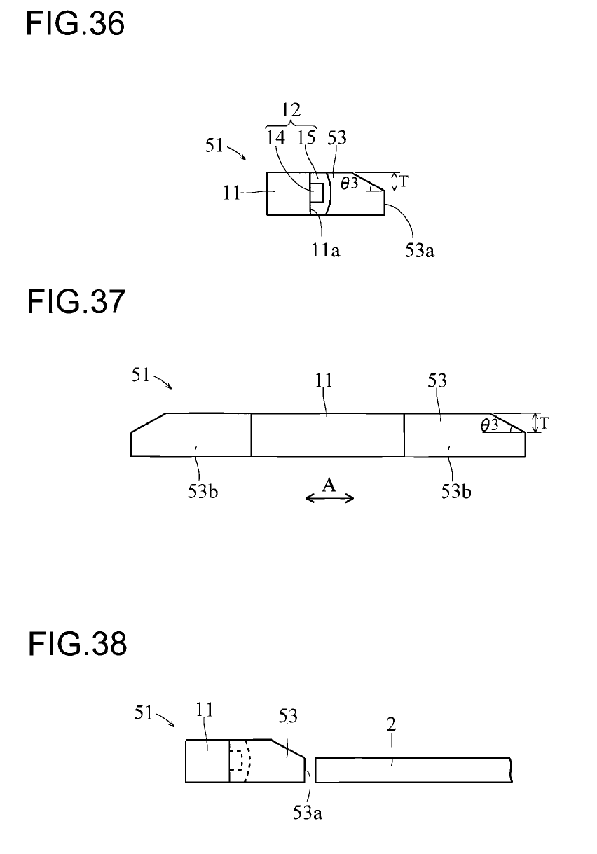

### BRIEF DESCRIPTION OF THE DRAWINGS

[FIG. 1] is a perspective view of an LED light source device according to a first embodiment of the present invention.

[FIG. 2] is a sectional view of the LED light source device shown in FIG. 1 according to the first embodiment.

[FIG. 3] is a drawing for describing a going direction of light in the inside of the LED light source device shown in FIG. 1 according to the first embodiment.

[FIG. 4] is a drawing for describing a first example of a wiring structure of the LED light source device shown in FIG. 1 according to the first embodiment.

[FIG. 5] is a drawing for describing the first example of the wiring structure of the LED light source device shown in FIG. 1 according to the first embodiment.

[FIG. 6] is a drawing for describing the first example of the wiring structure of the LED light source device shown in FIG. 1 according to the first embodiment.

[FIG. 7] is a drawing for describing the first example of the wiring structure of the LED light source device shown in FIG. 1 according to the first embodiment.

[FIG. 8] is a drawing for describing a second example of the wiring structure of the LED light source device shown in FIG. 1 according to the first embodiment.

[FIG. 9] is a drawing for describing the second example of the wiring structure of the LED light source device shown in FIG. 1 according to the first embodiment.

[FIG. 10] is a drawing for describing a third example of the wiring structure of the LED light source device shown in FIG. 1 according to the first embodiment.

[FIG. 11] is a drawing for describing the third example of the wiring structure of the LED light source device shown in FIG. 1 according to the first embodiment.

[FIG. 12] is a drawing for describing the third example of the wiring structure of the LED light source device shown in FIG. 1 according to the first embodiment.

[FIG. 13] is a perspective view of a backlight device which uses the LED light source device shown in FIG. 1 according to the first embodiment as a light source.

[FIG. 14] is a drawing of a state in which the LED light source device shown in FIG. 1 according to the first embodiment is mounted on a flexible printed wiring board.

[FIG. 15] is a drawing of a state in which the LED light source device shown in FIG. 1 according to the first embodiment is mounted on a flexible printed wiring board.

[FIG. 16] is a perspective view of a backlight device which uses the LED light source device shown in FIG. 1 according to the first embodiment as a light source.

[FIG. 17] is a perspective view of a backlight device which uses the LED light source device shown in FIG. 1 according to the first embodiment as a light source.

[FIG. 18] is a drawing for describing an effect of the first embodiment.

[FIG. 19] is a plan view for describing a fabrication process of the LED light source device according to the first embodiment of the present invention.

[FIG. 20] is a sectional view for describing a fabrication process of the LED light source device according to the first embodiment of the present invention.

[FIG. 21] is a plan view for describing a fabrication process of the LED light source device according to the first embodiment of the present invention.

[FIG. 22] is a sectional view for describing a fabrication process of the LED light source device according to the first embodiment of the present invention.

[FIG. 23] is a sectional view for describing a fabrication process of the LED light source device according to the first embodiment of the present invention.

[FIG. 24] is a sectional view for describing a fabrication process of the LED light source device according to the first embodiment of the present invention.

[FIG. 25] is a perspective view of an LED light source device according to a second embodiment of the present invention.

[FIG. 26] is a sectional view of the LED light source device shown in FIG. 25 according to the second embodiment.

[FIG. 27] a drawing for describing a going direction of light in the inside of the LED light source device shown in FIG. 25 according to the second embodiment.

[FIG. 28] is a perspective view of an LED light source device according to a third embodiment of the present invention.

[FIG. 29] is a sectional view of the LED light source device shown in FIG. 28 according to the third embodiment.

[FIG. 30] a drawing for describing a going direction of light in the inside of the LED light source device shown in FIG. 28 according to the third embodiment.

[FIG. 31] is a perspective view of an LED light source device according to a fourth embodiment of the present invention.

[FIG. 32] is a sectional view of the LED light source device shown in FIG. 31 according to the fourth embodiment.

[FIG. 33] a drawing for describing a going direction of light in the inside of the LED light source device shown in FIG. 31 according to the fourth embodiment.

[FIG. 34] is a perspective view of an LED light source device according to a fifth embodiment of the present invention.

[FIG. 35] is a sectional view of the LED light source device shown in FIG. 34 according to the fifth embodiment.

[FIG. 36] is a drawing for describing a shape of a transparent resin member of the LED light source device shown in FIG. 34 according to the fifth embodiment.

[FIG. 37] is a drawing for describing a shape of a transparent resin member of the LED light source device shown in FIG. 34 according to the fifth embodiment.

[FIG. 38] is a drawing for describing an effect of the fifth embodiment.

[FIG. 39] is a simplified view of a conventional backlight device.

[FIG. 40] is a simplified view of a conventional LED light source device.

[FIG. 41] is a simplified view of a conventional LED light source device.

[FIG. 42] is a drawing for describing a conventional problem.

### LIST OF REFERENCE SYMBOLS

1, 21, 31, 41, 51 LED light source devices
2 light guide plate
3 flexible printed wiring board (external device)
10 backlight device
11 base member
11a mount surface
11b side end surface (predetermined surface)
12 light emitting body
13, 23, 33, 43, 53 transparent resin member
13a, 23a, 33a, 43a, 53a light output surfaces
13b, 23b, 33b, 43b, 53b side end surfaces
13c, 23c, 33c, 43c, 53c concave portions
14 light emitting diode element
15 fluorescent body
16 electric power supply line
17 external terminal
20 liquid crystal display panel

### BEST MODE FOR CARRYING OUT THE INVENTION

### First Embodiment

First, a whole structure of an LED light source device according to a first embodiment is described with reference to FIG. 1 to FIG. 3.

An LED light source device 1 according to the first embodiment, as shown in FIG. 1 to FIG. 3, includes: a base member 11; a light emitting body 12; and a transparent resin member 13. The base member 11 is formed of a material (e.g., a high-heat resistant polymer resin, a ceramic and the like) that is conventionally used as a package member; and has a mount surface 11a that faces in a light output direction (direction in which light emitted from the LED light source device 1 goes).

The light emitting body 12 is used to generate light that is output from the LED light source device 1; and only one light emitting body 12 is mounted on the mount surface 11a of one base member 11. The light emitting body 12 includes: a light emitting diode element 14 that emits blue light, and a fluorescent body 15 that is excited by the blue light to emit yellow fluorescent light; and has a structure in which the light emitting diode element 14 is covered by the fluorescent body 15. In such a structure, when the light emitting diode element 14 is driven, the blue light is emitted from the light emitting diode element 14 and the yellow fluorescent light is emitted from the fluorescent body 15 that absorbs the blue light. As a result of this, in the light emitting body 12, light (white light) due to color mixing of the blue light and the yellow fluorescent light is generated. Here, the fluorescent body 15 included in the light emitting body 12 is YAG:Ce.

The transparent resin member 13 is formed of a material (e.g., a resin that has heat resistance such as an epoxy resin, a silicone resin and the like) that is conventionally used as an encapsulation member; and covers the light emitting body 12 over the mount surface 11a of the base member 11. Besides, the transparent resin member 13 has: a light output surface 13a that faces in the light output direction; and a pair of side end surfaces (side end surfaces that face in a lateral direction (A direction)) 13b that connect the light output surface 13a and the mount surface 11a of the base member 11 to each other. And, the light generated by the light emitting body 12 is guided by the transparent resin member 13 and output in the light output direction. In other words, the light generated by the light emitting body 12 is output from the light output surface 13a of the transparent resin member 13. Here, the transparent resin member 13 is so formed on the mount surface 11a of the base member 11 as not to reach an external terminal 17 described later (see FIG. 5).

Here, in the first embodiment, the side end surface 13b of the transparent resin member 13 is linearly inclined in such a way that a lateral-direction (A direction) length of the light output surface 13a of the transparent resin member 13 becomes longer than a lateral-direction length of the mount surface 11a of the base member 11. And, the interface between the linearly inclined side end surface 13b of the transparent resin member 13 and the atmosphere is made to function as a light reflection surface for reflecting the light in the light output direction in the inside of the transparent resin member 13. The inclination angle θ₁ of the linearly inclined side end surface 13b of the transparent resin member 13 is so set as to meet the following formula (1) when the refractive index of the atmosphere is n₀ and the refractive index of the transparent resin member 13 is n₁. Here, the inclination angle θ₁ is based on a normal of the light incident surface 13a of the transparent resin member 13.

70°≧θ₁>sin⁻¹(n₀/n₁) (1)

Besides, in the first embodiment, a light diffusion region for diffusing the light from the light emitting body 12 is disposed in the transparent resin member 13. The light diffusion region is disposed in a region that faces the light emitting body 12; and includes a V-shape concave portion 13c that is dug from the light output surface 13a of the transparent resin member 13 toward the base member 11 side. And, the inclination angle θ₂ of an inner surface of the V-shape concave portion 13c of the transparent resin member 13 is so set as to meet the following formula (2). Here, the inclination angle θ₂ is based on the normal of the light incident surface 13a of the transparent resin member 13.

70°≧θ₂≧45° (2)

As a result of this, in the first embodiment, in the inside of the transparent resin member 13, the light from the light emitting body 12 goes in arrow directions shown in FIG. 3. Specifically, the light from the light emitting body 12 is reflected in the light output direction at the interface between the linearly inclined side end surface 13b of the transparent resin member 13 and the atmosphere; and the light from the light emitting body 12 is so reflected at the interface between the inner surface of the V-shape concave portion 13c of the transparent resin member 13 and the atmosphere as to spread in the lateral direction (A direction).

Next, a first example of a wiring structure of the LED light source device according to the first embodiment is described with reference to FIG. 4 to FIG. 7.

In the first embodiment, as shown in FIG. 4 to FIG. 7, on the mount surface 11a of the base member 11, an electric power supply line 16 for supplying electric power to the light emitting diode element 14 is formed and divided into two portions. Besides, on each of a pair of side end surfaces (predetermined surfaces) 11b that face in the lateral direction (A direction) of the base member 11, the external terminal 17 that extends onto a surface that is situated on the side opposite to the mount surface 11a is formed. The electric power supply line 16 and the external terminal 17 are formed of the same material as each other and include a laminated body of a Cu-plated layer and a Ni—Ag-plated layer.

One electric power supply line 16 (16a) is connected to the external terminal 17 (17a) formed on one side end surface 11b of the base member 11, while the other electric power supply line 16 (16b) is connected to the external terminal 17 (17b) formed on the other side end surface 11b of the base member 11. And, one electrode of the light emitting diode element 14 is connected to the electric power supply line 16a (external terminal 17a), while the other electrode of the light emitting diode element 14 is connected to the electric power supply line 16b (external terminal 17b) via a wire 18. Here, the disposition positions of an anode electrode (Anode) and a cathode electrode (Cathode) of the LED light source device 1 are the same as the disposition positions of an anode electrode and a cathode electrode of the conventional LED light source device.

The wiring structure of the LED light source device 1, besides those shown in FIG. 4 to FIG. 7, may be structures shown in FIG. 8 to FIG. 12.

Specifically, like a second example shown in FIG. 8 and FIG. 9, both of the electric power supply lines 16a and 16b may be extended to the mount region 14a of the light emitting diode element 14 and connected to the light emitting diode element 14 by flip chip mounting.

Besides, like a third example shown in FIG. 10 to FIG. 12, the electric power supply line 16 and the external terminal 17 may be formed of materials different from each other. Specifically, a laminated body of a Cu-plated layer and a Ni—Ag-plated layer may be used for the electric power supply line 16, while an Au-plated layer may be used for the external terminal 17. Moreover, the external terminal 17 may be extended onto a side surface along the lateral direction (A direction).

Here, the LED light source device 1 in the first embodiment, as shown in FIG. 13, is able to be used as a light source of a backlight device 10 disposed in a liquid crystal display device. For example, if the backlight device 10 is an edge-light type, a light guide plate 2 is disposed on a rear surface of a liquid crystal display panel 20; and a plurality of LED light source devices 1 arranged a predetermined distance (e.g., 0.1 mm or longer) away from each other are mounted on a flexible printed wiring board (external device) 3 and so disposed as to face one of four side end surfaces of the light guide plate 2. In this case, the light output from the LED light source device 1 is introduced inside from a predetermined side end surface of the light guide plate 2 that faces the LED light source device 1; thereafter, is output from a front surface of the light guide plate 2 and shines on the rear surface of the liquid crystal display panel 20. As a result of this, a desired image is displayed on a display region 20a of the liquid crystal display device 20. Here, in such backlight device 10, an optical sheet 4 is disposed on the front surface of the light guide plate 2 and a reflection sheet 5 is disposed on a rear surface of the light guide plate 2. And, the light output from the front surface of the light guide plate 2 is diffused and collected by the optical sheet 4; and light leaking from the rear surface of the light guide plate 2 is reflected by the reflection sheet 5 to be reintroduced.

Besides, in the case where the LED light source device 1 according to the first embodiment is used as the light source of the backlight device 10, in the mounting of the LED light source device 1 onto the flexible printed wiring board 3, as shown in FIG. 14 and FIG. 15, the external terminal 17 of the LED light source device 1 and an external terminal 3a of the flexible printed wiring board 3 may be connected to each other by means of a solder 19. The mounting of the LED light source device 1 onto the flexible printed wiring board 3 is the same as the mounting of the conventional LED light source device onto the flexible printed wiring board 3. Because of this, in the case where the LED light source device 1 is used as the light source of the backlight device 10, it becomes easy to perform replacement from the conventional LED light source device.

Here, in the case where the LED light source device 1 according to the first embodiment is used as the light source of the backlight device 10, it is also possible to dispose the LED light source device 1 as shown in FIG. 16 and FIG. 17. In other words, by using the LED light source device 1 according to the first embodiment as the light source of the backlight device 10, it becomes easy to change the disposition position of the LED light source device 1 and improve the degree of freedom of the design.

In the first embodiment, as described above, the side end surface 13b of the transparent resin member 13 is linearly inclined, so that because the light generated by the light emitting body 12 reflects off the linearly inclined side end surface 13b of the transparent resin member 13, it is possible to prevent the light from being totally reflected at the interface between the light output surface 13a of the transparent resin member 13 and the atmosphere. Because of this, it is possible to increase the light that is output from the LED light source device 1. Accordingly, if the LED light source device 1 according to the first embodiment is used as the light source of the backlight device 10, the light introduced into the light guide plate 2 increases, so that it is possible to improve the brightness.

In this case, the side end surface 13b of the transparent resin member 13 is linearly inclined in such a way that the lateral-direction length of the light output surface 13a of the transparent resin member 13 becomes larger than the lateral-direction length of the mount surface 11a of the base member 11, so that because the light output surface 13a of the transparent resin member 13 becomes large in the lateral direction, it is possible to evenly spread the light output from the LED light source device 1 in the lateral direction. Accordingly, if the LED light source device 1 according to the first embodiment is used as the light source of the backlight device 10, in a case where it is tried to achieve narrow framing of the backlight device 10 by shortening the distance from the LED light source device 1 to the effective light emitting area (region corresponding to the display region 20a of the liquid crystal display panel 20), it is possible to prevent occurrence of a disadvantage that brightness unevenness (eyeball unevenness) occurs.

Moreover, by using the interface between the linearly inclined side end surface 13a of the transparent resin member 13 and the atmosphere as the light reflection surface for reflecting the light in the light output direction in the inside of the transparent resin member 13, there is no need to enclose the circumference of the light emitting diode element 14 by means of a light reflection member and the like separately prepared, so that it is possible to reduce the thickness (the height of the light output surface of the LED light source device 1) of the LED light source device 1. Accordingly, if the LED light source device 1 according to the first embodiment is used as the light source of the backlight device 10, in a case where it is tried to achieve thickness reduction of the backlight device 10 by reducing the thickness (the height of the light incident surface (predetermined side end surface) of the light guide plate 2) of the light guide plate 2, as shown in FIG. 18, it is possible to lower (e.g., about 0.5 mm) the height of the light output surface of the LED light source device 1 in accordance with the height of the light incident surface (predetermined side end surface) of the light guide plate 2. As a result of this, it is possible to prevent occurrence of a disadvantage that it becomes hard for the light output from the LED light source device 1 to enter the light guide plate 2; and because of this, the brightness becomes low.

Because of these results, by using the LED light source device 1 according to the first embodiment as the light source of the backlight device 10, even if it is tried to achieve size reduction (thickness reduction and narrow framing) of the backlight device 10, it is possible to prevent the brightness characteristic from becoming low.

Besides, in the first embodiment, as described above, by using the structure in which the light emitting diode element 14 is covered by the fluorescent body 15 as the light emitting body 12, in comparison with a case where the kinds of light emitting diode elements of: a light emitting diode element that emits red light, a light emitting diode element that emits green light and a light emitting diode element that emits blue light are used, it is possible to achieve further size reduction of the LED light source device 1.

Besides, in the first embodiment, as described above, the light output surface 13a of the transparent resin member 13 is provided with the V-shape concave portion 13c and the concave portion 13c of the transparent resin member 13 serves as the light diffusion region, so that it is possible to further widen the spread of the light in the lateral direction in the inside of the transparent resin member 13. Accordingly, if the LED light source device 1 according to the first embodiment is used as the light source of the backlight device 10, it becomes unnecessary to additionally form a light diffusion region in the light guide plate 2. In other words, because it becomes unnecessary to apply a complicated process to the light guide plate 2, it is possible to reduce the fabrication cost. Besides, in a case where the light guide plate 2 is provided with a light diffusion region, the position of the light diffusion region and the position of the LED light source device 1 are likely to deviate from each other to lower a light diffusion effect; however, in the first embodiment, such a disadvantage does not occur.

Besides, in the first embodiment, as described above, by employing the structure in which only one light emitting body 12 is mounted on one base member 11, in comparison with a structure in which a plurality of light emitting bodies 12 are mounted on the base member 11, it is possible to shorten the lateral-direction length of the base member 11. As a result of this, it is possible to prevent a warpage and the like from occurring in the base member 11. Accordingly, in the case where the LED light source device 1 according to the first embodiment is used as the light source of the backlight device 10, it is possible to prevent occurrence of a disadvantage that a warpage and the like occur in the base member 11 and because of this, the efficiency of incident light from the LED light source device 1 to the light guide plate 2 becomes low. Besides, it is possible to improve the fabrication yield better than the structure in which a plurality of light emitting bodies 12 are mounted on the base member 11.

Besides, in the first embodiment, as described above, on the mount surface 11a of the base member 11, the electric power supply line 16 for supplying electric power to the light emitting diode element 14 is divided into the tow portions and formed; and on each of the pair of side end surfaces 11b that face in the lateral direction of the base member 11, the external terminal 17 that connects to the electric power supply line 16 is formed, so that in mounting the light emitting diode element 14 onto the mount surface 11a of the base member 11, it is possible to easily perform electrical connection of the light emitting diode element 14 to the electric power supply line 16 (eternal terminal 17). Because of this, it is possible to improve the producibility of the LED light source device 1. Besides, because it is possible to enlarge the area of the external terminal 17, it is possible not only to easily perform the mounting of the LED light source device 1 onto the flexible printed wiring board 3 (electrical connection by a solder 19 between the external terminal 3a of the flexible printed wiring board 3 and the external terminal 17 of the LED light source device 1) but also to improve electrical conductivity from the flexible printed wiring board 3 to the light emitting diode element 14.

In this case, the transparent resin member 13 is so formed on the mount surface 11a of the base member 11 as not to reach the external terminal 17, so that because the light is not reflected by the external terminal 17 in the inside of the transparent resin member 13, it is possible to prevent an unintended light component from occurring. Besides, it is also possible to prevent a short from occurring between terminals.

Here, the electric power supply line 16 and the external terminal 17 include the laminated body of the Cu-plated layer and the Ni—Ag-plated layer, so that it is possible to further improve the electrical conductivity from the flexible printed wiring board 3 to the light emitting diode element 14 while preventing oxidation of the Cu and migration of the Ag. Besides, because it is possible to form the electric power supply line 16 and the external terminal 17 at the same time, it becomes possible to further improve the producibility of the LED light source device 1. Moreover, because it is possible to continuously form each layer of the electric power supply line 16 and of the external terminal 17, it becomes possible to lower the resistance and raise the light emitting efficiency (lm/W) in electric power conversion.

Besides, if a wiring structure which allows the flip chip mounting of the light emitting diode element 14 is employed, it is possible to omit a wire bonding process, so that it becomes possible to further improve the producibility of the LED light source device 1. Moreover, if the light emitting diode element 14 is flip-chip mounted, heat easily propagates to the base member 11, so that it is possible to prevent heat generation in the light emitting diode element 14 and improve the light emitting efficiency.

Besides, if the external terminal 17 is formed of an Au-plated layer, it is possible to improve durability of the external terminal 17. Besides, in a case where devices different from each other are mounted onto the flexible printed wiring board 3, it is easy to perform the mounting of these devices onto the flexible printed wiring board 3.

Next, a fabrication process of the LED light source device according to the first embodiment is described with reference to FIG. 19 to FIG. 24.

In fabricating the LED light source device 1 (see FIG. 1 and FIG. 2) according to the first embodiment, first, as shown in FIG. 19 and FIG. 20, the elongate base member 11 that is formed of a high-heat resistant polymer, a ceramic and the like is prepared. And, the base member 11 is provided a plurality of through-holes 11c that penetrate from an upper surface to a lower surface and are arranged a predetermined distance away from each other in a longitudinal direction (A direction). Here, a plurality of regions 1a in the figures are regions that turn into the LED light source device 1 later.

Next, as shown in FIG. 21 and FIG. 22, on each of the plurality of regions 1a on the upper surface of the base member 11, the electric power supply line 16 (16a and 16b), which includes the laminated body that is formed of the Cu-plated layer and the Ni—Ag-plated layer, is formed. Besides, at the same time, on each inner side surface of the plurality of through-holes 11c of the base member 11, the external terminal 17 (17a and 17b), which includes the laminated body that is formed of the Cu-plated layer and the Ni—Ag-plated layer, is formed. Here, in this time, the electric power supply line 16a and the external terminal 17a are connected to each other, while the electric power supply line 16b and the external terminal 17b are connected to each other.

Next, as shown in FIG. 23, a plurality of light emitting diode elements 14 that emit blue light are prepared; thereafter, each of the plurality of light emitting diode elements 14 is disposed on each of the plurality of regions 1a on the upper surface of the base member 11. And, a lower-surface electrode of each of the plurality of light emitting diode elements 14 is connected to the corresponding electric power supply line 16a. Besides, an upper-surface electrode of each of the plurality of light emitting diode elements 14 is connected to the corresponding electric power supply line 16b via the wire 18. Thereafter, each of the plurality of light emitting diode elements 14 is separately covered by means of the fluorescent body 15 that is formed of YAG: Ce. As a result of this, a state is brought, in which each of the light emitting bodies 12 is disposed in each of the plurality of regions 1a on the upper surface of the base member 11.

Next, as shown in FIG. 24, the transparent resin member 13, which is formed of a resin such as an epoxy resin, a silicone resin and the like that have heat resistance, is so formed on the upper surface of the base member 11 as to continuously cover the plurality of light emitting bodies 12. Thereafter, the structural body shown in FIG. 24 is cut along a broken line in the figure by means of a punching process that uses a punching member. As a result of this, the plurality of LED light source devices 1 (see FIG. 1 and FIG. 2) are fabricated at a time.

In the fabrication process in the above first embodiment, it is possible to fabricate the plurality of LED light source devices 1 by means of one punching process. Besides, it is easy to form the linearly inclined side end surface 13b and the concave portion 13c that serves as the light diffusion region on the transparent resin member 13.

### Second Embodiment

Next, a whole structure of an LED light source device according to a second embodiment is described with reference to FIG. 25 to FIG. 27.

In an LED light source device 21 according to the second embodiment, a transparent resin member 23 shown in FIG. 25 to FIG. 27 is used. The transparent resin member 23, like the transparent resin member 13 in the first embodiment, covers the light emitting body 12 over the mount surface 11a of the base member 11 and has: a light output surface 23a that faces in a light output direction; and a pair of side end surfaces (side end surfaces that face in the lateral direction (A direction)) 23b that connect the light output surface 23a and the mount surface 11a of the base member 11 to each other.

Here, in the second embodiment, the side end surface 23b of the transparent resin member 23 is inclined into a curved-surface shape in such a way that a lateral-direction (A direction) length of the light output surface 23a of the transparent resin member 23 becomes longer than a lateral-direction length of the mount surface 11a of the base member 11. And, the interface between the side end surface 23b of the transparent resin member 23 inclined into the curved-surface shape and the atmosphere is made to function as a light reflection surface for reflecting the light in the light output direction in the inside of the transparent resin member 23. The curvature of the side end surface 23b of the transparent resin member 23 inclined into the curved-surface shape is set in such a way that the light from the light emitting body 12 is totally reflected in the light output direction at the interface between the side end surface 23b of the transparent resin member 23 inclined into the curved-surface shape and the atmosphere.

Besides, in the second embodiment, a light diffusion region for diffusing the light from the light emitting body 12 is formed on the transparent resin member 23. The light diffusion region is similar to the light diffusion region in the first embodiment; is disposed on a region that faces the light emitting body 12; and includes a V-shape concave portion 23c that is dug from the light output surface 23a of the transparent resin member 23 toward the base member 11 side. Here, the inclination angle θ₂ of an inner surface of the V-shape concave portion 23c of the transparent resin member 23 is so set as to meet the formula (2) in the above first embodiment.

As a result of this, in the second embodiment, in the inside of the transparent resin member 23, the light from the light emitting body 12 goes in arrow directions shown in FIG. 27. Specifically, the light from the light emitting body 12 is reflected in the light output direction at the interface between the side end surface 23b of the transparent resin member 23 inclined in the curved-surface shape and the atmosphere; and the light from the light emitting body 12 is so reflected at the interface between the inner surface of the V-shape concave portion 23c of the transparent resin member 23 and the atmosphere as to spread in the lateral direction (A direction).

Here, the other structures in the second embodiment are the same as the above first embodiment.

In the second embodiment, according to the above structure, it is possible to obtain the same effects as in the first embodiment.

### Third Embodiment

Next, a whole structure of an LED light source device according to a third embodiment is described with reference to FIG. 28 to FIG. 30.

In an LED light source device 31 according to the third embodiment, a transparent resin member 33 shown in FIG. 28 to FIG. 30 is used. The transparent resin member 33, like the transparent resin member 13 according to the first embodiment, covers the light emitting body 12 over the mount surface 11a of the base member 11 and has: a light output surface 33a that faces in a light output direction; and a pair of side end surfaces (side end surfaces that face in the lateral direction (A direction)) 33b that connect the light output surface 33a and the mount surface 11a of the base member 11 to each other.

Here, in the third embodiment, like in the first embodiment, the side end surface 33b of the transparent resin member 33 is linearly inclined in such a way that a lateral-direction (A direction) length of the light output surface 33a of the transparent resin member 33 becomes longer than a lateral-direction length of the mount surface 11a of the base member 11. And, the interface between the linearly inclined side end surface 33b of the transparent resin member 33 and the atmosphere is made to function as a light reflection surface for reflecting the light in the light output direction in the inside of the transparent resin member 33. Here, the inclination angle θ₁ of the side end surface 33b of the transparent resin member 33 meets the formula (1) in the above first embodiment.

Besides, in the third embodiment, a light diffusion region for diffusing the light from the light emitting body 12 is formed on the transparent resin member 33. The light diffusion region is disposed on a region that faces the light emitting body 12; and includes a semicircular concave portion 33c that is dug from the light output surface 33a of the transparent resin member 33 toward the base member 11 side. And, the radius R of the semicircular concave portion 33c of the transparent resin member 33 is so set as to meet the following formula (3) when the long-edge length of the light emitting diode element 14 is L and the length from the light output surface 33a of the transparent resin member 33 to the light emitting diode element 14 is S.

S≧R≧L/2 (3)

As a result of this, in the third embodiment, in the inside of the transparent resin member 33, the light from the light emitting body 12 goes in arrow directions shown in FIG. 30. Specifically, the light from the light emitting body 12 is reflected in the light output direction at the interface between the linearly inclined side end surface 33b of the transparent resin member 33 and the atmosphere; and the light from the light emitting body 12 is so reflected at the interface between an inner surface of the semicircular concave portion 33c of the transparent resin member 33 and the atmosphere as to spread in the lateral direction (A direction).

Here, the other structures in the third embodiment are the same as the above first embodiment.

In the third embodiment, according to the above structure, it is possible to obtain the same effects as in the first embodiment.

Besides, in the third embodiment, the semicircular concave portion 33c is formed on the light output surface 33a of the transparent resin member 33; and the semicircular concave portion 33c is made to function as a light diffusion surface, so that it is possible to further improve the light diffusion effect in the inside of the transparent resin member 33.

### Fourth Embodiment

Next, a whole structure of an LED light source device according to a fourth embodiment is described with reference to FIG. 31 to FIG. 33.

In an LED light source device 41 according to the fourth embodiment, a transparent resin member 43 shown in FIG. 31 to FIG. 33 is used. The transparent resin member 43, like the transparent resin member 13 in the above first embodiment, covers the light emitting body 12 over the mount surface 11a of the base member 11 and has: a light output surface 43a that faces in a light output direction; and a pair of side end surfaces (side end surfaces that face in the lateral direction (A direction)) 43b that connect the light output surface 43a and the mount surface 11a of the base member 11 to each other.

Here, in the fourth embodiment, like in the second embodiment, the side end surface 43b of the transparent resin member 43 is inclined in a curved-surface shape in such a way that a lateral-direction (A direction) length of the light output surface 43a of the transparent resin member 43 becomes longer than a lateral-direction length of the mount surface 11a of the base member 11. And, the interface between the side end surface 43b of the transparent resin member 43 inclined in the curved-surface shape and the atmosphere is made to function as a light reflection surface for reflecting the light in the light output direction in the inside of the transparent resin member 43.

Besides, in the fourth embodiment, a light diffusion region for diffusing the light from the light emitting body 12 is formed on the transparent resin member 43. The light diffusion region is similar to the light diffusion region in the above third embodiment and disposed on a region that faces the light emitting body 12; and includes a semicircular concave portion 43c that is dug from the light output surface 43a of the transparent resin member 43 toward the base member 11 side. Here, the radius R of the semicircular concave portion 43c of the transparent resin member 43 meets the above formula (3) in the above third embodiment.

As a result of this, in the fourth embodiment, in the inside of the transparent resin member 43, the light from the light emitting body 12 goes in arrow directions shown in FIG. 33. Specifically, the light from the light emitting body 12 is reflected in the light output direction at the interface between the side end surface 43b of the transparent resin member 43 inclined in the curved-surface shape and the atmosphere; and the light from the light emitting body 12 is so reflected at the interface between an inner surface of the semicircular concave portion 43c of the transparent resin member 43 and the atmosphere as to spread in the lateral direction (A direction).

Here, the other structures in the fourth embodiment are the same as the above first embodiment.

In the fourth embodiment, according to the above structure, it is possible to obtain the same effects as in the second and third embodiments.

### Fifth Embodiment

Next, a whole structure of an LED light source device according to a fifth embodiment is described with reference to FIG. 34 to FIG. 37.

In an LED light source device 51 according to the fifth embodiment, a transparent resin member 53 shown in FIG. 34 to FIG. 37 is used. The transparent resin member 53, like the transparent resin member 13 in above the first embodiment, covers the light emitting body 12 over the mount surface 11a of the base member 11 and has: a light output surface 53a that faces in a light output direction; and a pair of side end surfaces (side end surfaces that face in the lateral direction (A direction)) 53b that connect the light output surface 53a and the mount surface 11a of the base member 11 to each other.

Here, in the fifth embodiment, like in the first embodiment, the side end surface 53b of the transparent resin member 53 is linearly inclined in such a way that a lateral-direction (A direction) length of the light output surface 53a of the transparent resin member 53 becomes longer than a lateral-direction length of the mount surface 11a of the base member 11. And, the interface between the linearly inclined side end surface 53b of the transparent resin member 53 and the atmosphere is made to function as a light reflection surface for reflecting the light in the light output direction in the inside of the transparent resin member 53.

Besides, in the fifth embodiment, like in the above first embodiment, a light diffusion region (V-shape concave portion 53c) for diffusing the light from the light emitting body 12 in the lateral direction (A direction) is formed on the light output surface 53a of the transparent resin member 53.

Moreover, in the fifth embodiment, the thickness of the light output surface 53a side of the transparent resin member 53 is smaller than the thickness of the base member 11 side. Specifically, the thickness of the transparent resin member 53 gradually becomes smaller from the base member 11 side toward the light output surface 53a side at an inclination angle θ₃ of 20° or larger to an angle smaller than 45°; and a difference T between the thickness of the light output surface 53a side of the transparent resin member 53 and the thickness of the base member 11 side is 0.1 mm or larger.

Here, the other structures in the fifth embodiment are the same as the above first embodiment.

In the fifth embodiment, according to the above structure, it is possible to obtain the same effects as in the first embodiment.

Besides, in the fifth embodiment, as described above, if the thickness of the light output surface 53a side of the transparent resin member 53 is made smaller than thickness of the base member 11 side and used as the light source of the backlight device 10 (see FIG. 13) of the LED light source device 51 according to the fifth embodiment, as shown in FIG. 38, even if the thickness (the height of the light incident surface (predetermined side end surface) of the light guide plate 2) of the light guide plate 2 is made smaller (e.g., about 0.35 mm) than the first embodiment, a disadvantage that it becomes hard for the light output from the LED light source device 51 to enter the light guide plate 2 does not occur. Because of this, it is possible to achieve further thickness reduction of the backlight device 10.

It should be considered that the embodiments disclosed this time are examples in all respects and are not limiting. The scope of the present invention is not indicated by the above description of the above embodiments but by the claims, and all modifications within the scope of the claims and the meaning equivalent to the claims are covered.

1. An LED light source device comprising:
a base member that has a mount surface facing in a light output direction;
a light emitting body that is mounted on the mount surface of the base member and includes at least a light emitting diode element; and
a transparent resin member that is so formed on the mount surface of the base member as to cover the light emitting body; has a light output surface facing in the light output direction and a side end surface for connecting the light output surface and the mount surface of the base member to each other; guides light generated by the light emitting body to output the light from the light output surface; wherein
the side end surface of the transparent resin member is inclined in such a way that a lateral-direction length of the light output surface becomes longer than the lateral-direction length of the mount surface of the base member; and
an interface between the side end surface inclined of the transparent resin member and atmosphere serves as a light reflection surface.

2. The LED light source device according to claim 1, wherein
the light emitting body includes: a light emitting diode element for emitting blue light, and a fluorescent body for absorbing the blue light to emit fluorescent light; and
emits white light obtained by color-mixing the blue light and the fluorescent light with each other.

3. The LED light source device according to claim 1, wherein
the side end surface of the transparent resin member is linearly inclined; and
when a refractive index of the atmosphere is n₀ and a refractive index of the transparent resin member is n₁, an inclination angle θ₁ of the side end surface of the transparent resin member to a normal of the light output surface is so set as to meet 70°≧₁>sin^{-l}(n₀/n₁).

4. The LED light source device according to claim 1, wherein
the side end surface of the transparent resin member is inclined in a curved-surface shape; and
a curvature of the side end surface of the transparent resin member is set in such a way that the light from the light emitting body is totally reflected in the light output direction at the interface between the side end surface of the transparent resin member and the atmosphere.

5. The LED light source device according to claim 1, wherein
the transparent resin member is provided with a concave portion that is dug from the light output surface toward the base member side.

6. The LED light source device according to claim 5, wherein
the concave portion of the transparent resin member is formed into a V shape; and
an inclination angle θ₂ of an inner surface of the concave portion of the transparent resin member to a normal of the light output surface is so set as to meet 70°≧θ₂≧45°.

7. The LED light source device according to claim 5, wherein
the concave portion of the transparent resin member is formed into a semicircular shape; and
when a length of a long edge of the light emitting diode element is L and a length from the light emitting diode element to the light output surface is S, a radius R of the concave portion of the transparent resin member is so set as to meet S≧R≧L/2.

8. The LED light source device according to claim 1, wherein
the transparent resin member is formed in such a way that thickness of the light output surface side becomes smaller than thickness of the base member side.

9. The LED light source device according to claim 8, wherein
the transparent resin member is formed in such a way that the thickness gradually becomes smaller from the base member side toward the light output surface side at an inclination angle of 20° or lager to an angle smaller than 45°; and a difference between the thickness of the light output surface side and the thickness of the base member side becomes 0.1 mm or larger.

10. The LED light source device according to claim 1, wherein
on the mount surface of the base member, an electric power supply line that supplies electric power to the light emitting diode element is formed; and on a predetermined surface different from the mount surface of the base member, an external terminal connected to the electric power supply line is formed.

11. The LED light source device according to claim 10, wherein
at least one of the electric power supply line and the external terminal includes a laminated body of a Cu-plated layer and a Ni—Ag-plated layer.

12. The LED light source device according to claim 11, wherein
the electric power supply line includes a laminated body of a Cu-plated layer and a Ni—Ag-plated layer; and
the external terminal includes an Au-plated layer.

13. A backlight device comprising the LED light source device according to claim 1.

14. A liquid crystal display device comprising:
the backlight device according to claim 13; and
a liquid crystal display panel onto which light from the backlight device is shined.

15. A backlight device comprising the LED light source device according to claim 2.

16. A backlight device comprising the LED light source device according to claim 3.

17. A backlight device comprising the LED light source device according to claim 4.

18. A backlight device comprising the LED light source device according to claim 5.

19. A backlight device comprising the LED light source device according to claim 6.

20. A backlight device comprising the LED light source device according to claim 7.
